(19) United States
(12) Patent Application Publication
(10) Pub. No.: US 2022/0381482 A1
(43) Pub. Date: Dec. 1, 2022

(54) BRANCHED OXYDISILANE/SILOXANE OLIGOMERS AND METHODS FOR THEIR PREPARATION AND USE AS HEAT TRANSFER FLUIDS

(71) Applicants: Dow Silicones Corporation, Midland, MI (US); Dow Global Technologies LLC, Midland, MI (US)

(72) Inventors: Yang Cheng, Midland, MI (US); John B. Cuthbert, Midland, MI (US); Christoph Lang, Schindellegi (CH); Xiaoyuan Zhou, Midland, MI (US); Eric Joffre, Midland, MI (US); Gerald L. Witucki, Midland, MI (US)

(21) Appl. No.: 17/761,236

(22) PCT Filed: Nov. 9, 2020
(86) PCT No.: PCT/US2020/059601

§ 371 Date: Mar. 17, 2022

Related U.S. Application Data
(60) Provisional application No. 62/942,783, filed on Dec. 3, 2019.

(51) Int. Cl. F24S 80/20; C09K 5/12; C07F 7/12

(52) U.S. Cl. CPC F24S 80/20; C09K 5/12; C07F 7/12; F24S 10/00

(57) ABSTRACT

A branched oxydisilane/siloxane oligomer and method for its preparation are disclosed. The branched oxydisilane/siloxane oligomer may be used as a heat transfer fluid.

### CROSS REFERENCE TO RELATED APPLICATIONS

This application claims the benefit of U.S. Provisional Patent Application Ser. No. 62/942,783 filed on Dec. 3, 2019 under 35 U.S.C. § 119(e). U.S. Provisional Patent Application Ser. No. 62/942,783 is hereby incorporated by reference.

### TECHNICAL FIELD

A branched oxydisilane/siloxane oligomer and methods for its preparation and use are disclosed. The method for making the oligomer employs disilane components of direct process residue (DPR) as starting materials. The oligomer may be useful as a heat transfer fluid (HTF).

### BACKGROUND

The direct process for making organofunctional halosilane monomers, such as methylchlorosilane monomers, is performed on a commercial scale by reacting metallurgical grade silicon metal particles with an organic halide (e.g., methyl chloride) in a fluidized bed reactor (FBR). The direct process will produce a mixture of organofunctional halosilane monomers, such as dimethyldichlorosilane (Me₂SiCl₂) along with other species such as methyltrichlorosilane (MeSiCl₃) and trimethylchlorosilane (Me₃SiCl). Catalysts and/or promoters can be added to the FBR to improve yield and/or selectivity to desired organofunctional halosilane monomers.

At the end of a direct process campaign, the DPR must be disposed of. DPR typically contains unreacted silicon metal, metal impurities, organofunctional halosilane monomers, and high boiling components. The organofunctional halosilane monomers may be removed from DPR by conventional means such as stripping and/or distillation. The high boiling components may include compounds containing Si—Si, Si—O—Si, Si—C—Si, Si—C—C—Si, and Si—C—C—C—Si linkages in the molecules. Typical compounds in a high boiling component of DPR are described, for example, in U.S. Pat. Nos. 2,598,435; 2,681,355; and 8,852,545. It is desirable to recycle and/or reuse certain organofunctional halosilane monomers and high boiling components of DPR to minimize waste from the direct process.

The Concentrated Solar Power (CSP) industry needs heat transfer fluids (HTFs) that can be used at high temperature for prolonged periods. CSP plants use mirrors or lenses to concentrate solar energy from a large area of sunlight onto a receiver. A heat transfer fluid can be heated in the receiver and circulated to transport thermal energy and produce steam in a turbine, which can power a generator to produce electricity. CSP plants may employ linear Fresnel reflector (LFR) systems, power tower systems, dish engine systems, and/or parabolic trough systems to concentrate solar energy onto the receiver.

LFR employs long parallel rows of flat mirrors instead of curved mirrors. These focus solar energy onto elevated receivers (located above the mirrors), which have a system of tubes through which an HTF flows.

Power tower systems use a central receiver system. Computer-controlled mirrors (called heliostats) track the sun and focus solar energy on a receiver at the top of a tower. The focused energy is used to heat an HTF in the receiver. The heated HTF can be used to produce steam and run a central power generator.

In dish engine systems, mirrors are distributed over a parabolic dish surface to concentrate sunlight on a receiver fixed at the focal point. The receiver contains an HTF that is heated in the receiver. The system uses the heated HTF to generate mechanical power that runs a generator or alternator to produce electricity.

Parabolic trough systems use curved mirrors to focus sunlight onto a receiver tube that runs through a trough. In the receiver tube, a heat transfer fluid can absorb the solar energy and pass through a heat exchanger to heat water and produce steam. The steam can drive a steam turbine to generate electricity. HTFs based on an eutectic mixture of 73.5 wt. % diphenyl oxide (DPO) and 26.5 wt. % biphenyl (BP) such as DOWTHERM™ A (DTA) Heat Transfer Fluid have been commonly used in CSP plants with parabolic trough (PT) collector technology since the 1980's. In these CSP plants the HTF absorbs heat from the sun at PT collectors and transfers it to the power block where steam is generated and expanded in turbines that drive generators to produce electricity.

One way to reduce the cost of CSP is increasing the operating temperature of the HTF. The current DPO/BP HTF used in most of the 60 PT CSP plants is operated at temperatures between about 293° C. (560° F.) and about 393° C. (740° F.). This allows the steam Rankine cycle to operate at about 383° C. (721° F.) that limits the efficiency of the water steam Rankine cycle to about 38.4%. An increase of the maximum HTF temperature to 530° C. (986° F.) for example could increase the superheated steam temperature of the Rankine cycle to 520° C. (968° F.) allowing a cycle efficiency of 42.7%.

The higher efficiency of the Rankine cycle would allow a reduction of the solar field size that would allow savings in capital cost and maintenance. CSP plants with thermal storage also benefit from higher operating temperatures as the storage size can be reduced which results in cost savings for capital, operating cost.

The maximum operating temperature of 393° C. (739° F.) of PT CSP plants is set by HTF suppliers' restriction of the maximum operating temperature of DPO/BP HTF to 400° C. (750° F.) due to accelerated thermal aging above that temperature.

The CSP industry needs HTFs with higher thermal stability than DOWTHERM™ A Heat Transfer Fluid, but also with a freeze point at ambient temperatures or below, low vapor pressure and excellent heat transfer properties. SYLTHERM™ 800 Heat Transfer Fluid has been widely used for cooling and heating applications up to 400° C. This product is a linear polydimethylsiloxane (PDMS) with a viscosity of 10 mPa·s (measured at 20° C.). However, it has not been selected for commercial CSP plants due to higher cost compared to DPO/BP based HTF. If linear PDMS such as SYLTHERM™ 800 Heat Transfer Fluid is heated at high temperatures for extended periods of time, vapor pressure may increase and/or viscosity may decrease.

### SUMMARY

A branched oxydisilane/siloxane oligomer may be used as a HTF. The branched oxydisilane/siloxane oligomer may be made using components of DPR.

The branched oxydisilane/siloxane oligomer comprises unit formula: (R″₄Si₂O_{2/2})ₘ(R″₃Si₂O_{3/2})ₙ(R″₂Si₂O_{4/2})ₒ(R₃SiO_{1/2})_{z}(HO_{1/2})_{y}, where each R″ is an independently selected alkyl group of 1 to 6 carbon atoms; each R is an independently selected monovalent hydrocarbon group of 1 to 6 carbon atoms; subscript m≥0, subscript n≥0, subscript o≥0, with the provisos that a quantity (n+o)≥1, and a quantity (m+n+o)≤3; subscript y≥0, subscript z≥3; and a quantity (y+z)=[n+(2×o)+2].

A method for preparing a branched oxydisilane/siloxane oligomer comprises:
1) combining starting materials comprising:
   A) a triorganohalosilane of formula R₃SiX, where each R is an independently selected monovalent hydrocarbon group of 1 to 6 carbon atoms, and each X is an independently selected halogen atom, and
   B) a halodisilane of formula

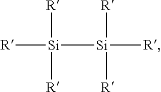

where each R′ is independently selected from the group consisting of an alkyl group of 1 to 6 carbon atoms and a halogen atom, with the proviso that an average of >2 instances of R′ per molecule are halogen atoms, and
2) adding the mixture to a starting material comprising C) water, thereby forming a reaction product comprising the branched oxydisilane/siloxane oligomer.

### DETAILED DESCRIPTION

The branched oxydisilane/siloxane oligomer comprises unit formula: (R″₄Si₂O_{2/2})ₘ(R″₃Si₂O_{3/2})ₙ(R″₂Si₂O_{4/2})ₒ(R₃SiO_{1/2})_{z}(HO_{1/2})_{y}, where each R″ is an independently selected alkyl group of 1 to 6 carbon atoms; each R is an independently selected monovalent hydrocarbon group of 1 to 6 carbon atoms; subscript m≥0, subscript n≥0, subscript o≥0, with the provisos that a quantity (n+o)≥1, and a quantity (m+n+o)≤3; and subscript y≥0, subscript z≥3; and a quantity (y+z)=[n+(2×o)+2]. Alternatively, m may be >0, alternatively 1 to 2. Alternatively, m may be 0. Alternatively, n may be 1 to 3, alternatively 1 to 2. Alternatively, o may be 1 to 3, alternatively 1 to 2. Alternatively, y may be 0. Suitable monovalent hydrocarbon groups for R include alkyl, alkenyl, and aryl groups. For example, the alkyl group may be methyl, ethyl, propyl (including n-propyl and/or iso-propyl), and butyl (including n-butyl, t-butyl, sec-butyl and/or iso-butyl). The alkenyl group may be vinyl, allyl, or hexenyl. The aryl group may be phenyl. Alternatively, each R may be methyl, vinyl or phenyl; alternatively methyl. Each R″ is an alkyl group as described above for R. Alternatively, each R″ may be methyl.

Examples of branched oxydisilane/siloxane oligomers that may be prepared as described herein include species having empirical formulae including, but not limited to: C₂₂H₆₆O₇Si₁₀, C₁₉H₅₈O₇Si₉, C₂₀H₆₀O₆Si₉, C₁₇H₅₂O₆Si₈, and a combination of two or more thereof. Characterization of such branched oxydisilane/siloxane oligomers are shown below in Table 1.

TABLE 1
Branched Oxydisilane/siloxane Oligomer Species (typical examples)

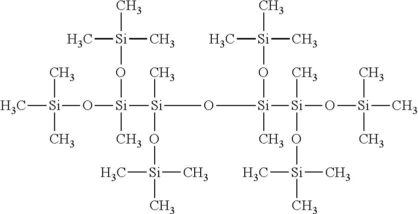

Chemical Formula: C₂₂H₆₆O₇Si₁₀ with mass 722.25

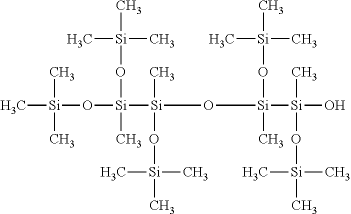

Chemical Formula: C₁₉H₅₈O₇Si₉ with mass 650.21

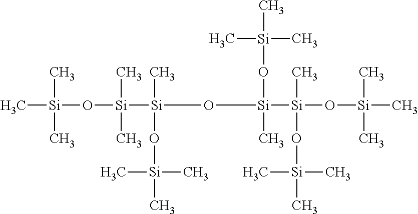

Chemical Formula: C₂₀H₆₀O₆Si₉ with mass 648.23

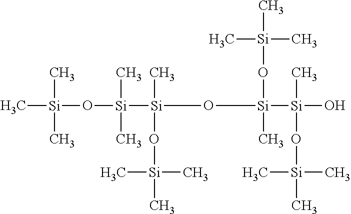

Chemical Formula: C₁₇H₅₂O₆Si₈ with mass 576.19

Branched oxydisilane/siloxane oligomer s above may be prepared by a method comprising:
1) combining starting materials comprising:
   A) a triorganohalosilane of formula R₃SiX, where R is a monovalent hydrocarbon group of 1 to 6 carbon atoms as described above, and each X is an independently selected halogen atom, and
   B) a halodisilane of formula

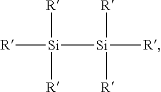

where each R′ is independently selected from the group consisting of alkyl groups of 1 to 6 carbon atoms and a halogen atom as described above for X , with the proviso that an average of >2 R′ per molecule are halogen atoms, and
2) adding the mixture to a starting material comprising C) water, thereby forming a reaction product comprising the branched oxydisilane/siloxane oligomer.

The method described above may optionally further comprise one or more additional steps. The method may optionally further comprise: adding D) a strong acid to C) the water before step 2). The method may further comprise: 3) adding E) an organic solvent to the reaction product, thereby preparing an incompatible mixture comprising an organic phase and an aqueous phase, 4) phase separating the incompatible mixture, thereby recovering the organic phase and the aqueous phase in separate vessels, and 5) washing the organic phase with F) a neutralizing agent. The method may optionally further comprise: 6) repeating steps 4) and 5) two or more times. The method described above may optionally further comprise: 7) drying the reaction product, e.g., to remove water introduced in the aqueous phase in step 5). The method described above may further optionally comprises: 8) combining the branched oxydisilane/siloxane oligomer with H) a capping agent. The method described above may further optionally comprises: 9) recovering the branched oxydisilane/siloxane oligomer.

In the method described above, e.g., in step 1), starting material A) and starting material B) may be added in amount such that at least 1 mole of halogen atoms on starting material A) :1 mole of halogen atoms on starting material B) are present (i.e., A:B ratio is ≥1:1). Alternatively, A:B ratio may be ≥1.5:1, and alternatively A:B ratio may be 1.5:1 to 2:1. Without wishing to be bound by theory, it is thought that when A:B ratio is ≥1.5:1, the resulting branched oxydisilane/siloxane oligomer will have improved heat stability.

The starting materials that may be used in the method described above include A) the triorganohalosilane, B) the halodisilane, C) deionized water, D) a strong acid, E) an organic solvent, F) a neutralizing agent, G) a drying agent, and H) a capping agent, and these starting materials are further described below.

### A) Triorganohalosilane

DPR typically comprises a triorganohalosilane, which may be recovered by conventional means such as stripping and/or distillation. The triorganohalosilane may have formula R₃SiX, where each R is an independently selected monovalent hydrocarbon group of 1 to 6 carbon atoms as described above, and each X is an independently selected halogen atom. Each X may be independently selected from the group consisting of bromine (Br), chlorine (Cl), fluorine (F), and iodine (I); alternatively Br, Cl, and F; alternatively Br and Cl; and alternatively each X may be Cl. Examples of the triorganohalosilane include trimethylchlorosilane.

### B) Halodisilane

DPR typically comprises a halodisilane as a high boiling component. The halodisilane

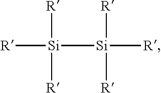

may have formula where each R′ is independently selected from the group consisting of alkyl groups of 1 to 6 carbon atoms and a halogen atom as described above for X, with the proviso that an average of ≥2 R′ per molecule are halogen atoms. Alternatively, each R′ is independently selected from methyl and Cl, with the proviso that at least 2, alternatively at 2 to 4, and alternatively 3 to 4, instances of R′ per molecule are Cl. The halodisilane may be selected from the group consisting of hexachlorodisilane, pentachloromethyldisilane, tetramethyldichlorodisilane, trimethyltrichlorodisilane, dimethyltetrachlorodisilane, and combinations of two or more thereof. Alternatively, the halodisilane may be selected from the group consisting of tetramethyldichlorodisilane, trimethyltrichlorodisilane, dimethyltetrachlorodisilane, and combinations of two or more thereof.

### C) Water

The water used in the method is not specifically restricted. For example, deionized water may be used. However, an excess of water may be used, for example a large excess, such as any amount sufficient to absorb the hydrogen halide (e.g., HCl), which is generated by chemical reaction of starting materials A), B) and C), such as up to 6 molar equivalents of water based on combined weights of starting materials A) and B).

### D) Strong Acid

Starting material D) is a strong acid that may optionally be used in the method, as described above. The strong acid may be, for example, trifluoromethanesulfonic acid, dodecylbenzene sulfonic acid, or a compound of formula (i) [M]^{x+}[R⁴SO₃⁻]ₓ where M is a metal atom selected from Aluminum (Al), Bismuth (Bi), Cerium (Ce), Chromium (Cr), Iron (Fe), Gallium (Ga), Indium (In), Lanthanum (La), Scandium (Sc), Samarium (Sm), and Ytterbium (Yb); R⁴ is selected from an oxygen atom (O) and CF₃; and x represents a number up to the maximum valence of the metal atom selected for M. Alternatively, x is 2 to 3; alternatively x=3. Alternatively, M is selected from Bi, Fe, Ga, and Sc; alternatively M is Bi, Fe, or Ga; alternatively M is Bi, Fe, or Sc; alternatively M is Bi or Fe; alternatively M is Fe, Ga, or Sc; alternatively, M is Fe or Ga; and alternatively M is Fe. Alternatively, R⁴ is O. Examples of suitable metal sulfate catalysts (where, in formula (i), R⁴ is O) include Cr₂(SO₄)₃ and Fe₂(SO₄)₃. Alternatively, formula (i) may represent a metal triflate; i.e., in formula (i) R⁴ is CF₃. Examples of suitable metal triflates include Aluminum(III) trifluoromethane sulfonate Al(OTf)₃, Bismuth(III) trifluoromethane sulfonate Bi(OTf)₃, Cerium(III) trifluoromethane sulfonate Ce(OTf)₃, Iron(III) trifluoromethane sulfonate Fe(OTf)₃, Gallium(III) trifluoromethane sulfonate Ga(OTf)₃, Indium(III) trifluoromethane sulfonate In(OTf)₃, Lanthanum(III) trifluoromethane sulfonate La(OTf)₃, Scandium(III) trifluoromethane sulfonate Sc(OTf)₃, Samarium(III) trifluoromethane sulfonate Sm(OTf)₃, and Ytterbium(III) trifluoromethane sulfonate Yb(OTf)₃. Alternatively, the metal triflate may be Bismuth(III) trifluoromethane sulfonate, Gallium(III) trifluoromethane sulfonate, Iron(III) trifluoromethane sulfonate, or Scandium(III) trifluoromethane sulfonate. Compounds of formula (i) are commercially available. For example, Al(OTf)₃, Bi(OTf)₃, Ce(OTf)₃, Fe(OTf)₃, In(OTf)₃, La(OTf)₃, Sc(OTf)₃, Sm(OTf)₃, Yb(OTf)₃, Cr₂(SO₄)₃, and Fe₂(SO₄)₃ are each available from Millipore-Sigma, of St. Louis, Mo., USA.

The amount of starting material D) used in the method will depend on various factors including the type and amount of starting materials A) and B). However, the amount of starting material D) may be at 1 mole % to 10 mole %, based on combined amounts of starting materials A) and B).

### E) Organic Solvent

Suitable organic solvents for use in the method described above will phase separate with aqueous materials and may include, for example, aromatic hydrocarbons and aliphatic hydrocarbons. Suitable aromatic hydrocarbons are exemplified by benzene, toluene, or xylene. Suitable aliphatic hydrocarbons are exemplified by heptane, hexane, or octane. Suitable solvents are known in the art and are commercially available, e.g., from Millipore-Sigma, of St. Louis, Mo., USA.

The amount of solvent will depend on various factors including the type of solvent selected and the number of washes to be employed. However, the amount of solvent may be 5 weight % to 100 weight %, alternatively 5% to 50%, and alternatively 10% to 25%, based on combined weights of all starting materials used in the method.

### F) Neutralizing Agent

The neutralizing agent used in the method may be sodium bicarbonate, sodium carbonate, ammonia, potassium carbonate, and/or potassium bicarbonate. The neutralizing agent may be an aqueous solution. Suitable neutralizing agents are known in the art and are commercially available, e.g., from Millipore-Sigma, of St. Louis, Mo., USA. The amount of neutralizing agent is sufficient to neutralize the reaction product. The aqueous solution may be used in any amount sufficient to neutralize, e.g., 10% to 25% based on weight of the starting materials.

### G) Drying Agent

The method described above may optionally include use of a drying agent e.g., to bind water from various sources. For example, the drying agent may bind residual water from the aqueous phase introduced with the neutralizing agent.

Examples of suitable drying agents for starting material G) may be adsorbents, which can be inorganic particulates. The adsorbent may have a particle size of 10 micrometers or less, alternatively 5 micrometers or less. The adsorbent may have average pore size sufficient to adsorb water and alcohols, for example 10 Å (Angstroms) or less, alternatively 5 Å or less, and alternatively 3 Å or less. Examples of adsorbents include zeolites such as chabasite, mordenite, and analcite; molecular sieves such as alkali metal alumino silicates, silica gel, silica-magnesia gel, activated carbon, activated alumina, calcium oxide, and combinations thereof.

Examples of commercially available drying agents include dry molecular sieves, such as 3 Å (Angstrom) molecular sieves, which are commercially available from Grace Davidson under the trademark SYLOSIV™ and from Zeochem of Louisville, Ky., U.S.A. under the trade name PURMOL, and 4 Å molecular sieves such as Doucil zeolite 4A available from Ineos Silicas of Warrington, England. Other useful molecular sieves include MOLSIV ADSORBENT TYPE 13X, 3A, 4A, and 5A, all of which are commercially available from UOP of Ill., U.S.A.; SILIPORITE NK 30AP and 65xP from Atofina of Philadelphia, Pa., U.S.A.; and molecular sieves available from W.R. Grace of Md., U.S.A.

Alternatively, the drying agent may bind the water and/or other by-products by chemical means. Suitable chemical drying agents include magnesium sulfate (MgSO₄) and sodium sulfate (Na₂SO₄).

The amount of starting material G) depends on the specific drying agent selected. However, when starting material G) is a chemical drying agent, the amount may range from 5% to 20%, alternatively 5% to 10% based on the total weight of all starting materials.

### H) Capping Agent

The process for preparing the branched oxydisilane/siloxane oligomer may optionally further comprise: adding starting material H) a capping agent. Without wishing to be bound by theory, it is thought that the capping agent may be used to cap silanol groups that may be present on the branched oxydisilane/siloxane oligomer to produce trihydrocarbylsiloxy (e.g., trialkyl-siloxy) groups. Suitable capping agents are exemplified by (H1) a monoalkoxysilane, (H2) a silazane, (H3) a siloxane oligomer, or two or more of (H1), (H2), and (H3).

The (H1) monoalkoxysilane may have formula (H4): R¹⁶₃SiOR¹⁷, where each R¹⁶ is independently a monovalent organic group unreactive with silanol functionality and each R¹⁷ is a monovalent hydrocarbon group of 1 to 6 carbon atoms. Alternatively, R¹⁷ may be an alkyl group of 1 to 6 carbon atoms, alternatively 1 to 4 carbon atoms, alternatively 1 to 2 carbon atoms, and alternatively R¹⁷ may be methyl. Each R¹⁶ may be a monovalent hydrocarbon group selected from alkyl, alkenyl, and aryl groups. Alternatively, each R¹⁶ may be an alkyl group of 1 to 6 carbon atoms, an alkenyl group of 2 to 6 carbon atoms or a phenyl group. Alternatively, each R¹⁶ may be an alkyl group of 1 to 6 carbon atoms, alternatively 1 to 4 carbon atoms, and alternatively each R¹⁶ may be methyl. Examples of monoalkoxysilanes for starting material (H1) include (H5) trimethylmethoxysilane and (H6) trimethylethoxysilane.

Suitable (H2) silazanes may have formula (H7): (R¹⁸R¹⁹₂Si)₂NH, where each R¹⁸ is independently selected from a monovalent hydrocarbon group (as described herein for R⁸) and a monovalent halogenated hydrocarbon group (such as a monovalent hydrocarbon group of R⁸ wherein at least one hydrogen has been replaced with a halogen atom, such as Cl or F), each R¹⁹ is an independently selected monovalent hydrocarbon group of 1 to 6 carbon atoms, as described above for R¹⁷. Each R¹⁸ may be an alkyl group, an alkenyl group, or a halogenated alkyl group. Suitable alkyl groups for R¹⁸ include methyl, ethyl, propyl, and butyl. Suitable alkenyl groups include vinyl and allyl. Suitable halogenated alkyl groups include trifluoropropyl. Examples of suitable silazanes for starting material (H2) include (H8) hexamethyldisilazane, (H9) sym-tetramethyldivinyldisilazane, and (H10) [(CF₃CH₂CH₂)(CH₃)₂Si]₂NH.

The (H3) siloxane oligomer may have formula (H11): (R²⁰R²¹₂Si)—O—(SiR²⁰R²¹₂), where each R²⁰ is independently selected from a monovalent hydrocarbon group (as described herein for R⁸) and a monovalent halogenated hydrocarbon group (such as a monovalent hydrocarbon group of R⁸ wherein at least one hydrogen has been replaced with a halogen atom, such as Cl or F), each R²¹ is an independently selected monovalent hydrocarbon group of 1 to 6 carbon atoms, as described above for R¹⁷. Each R²⁰ may be an alkyl group, an alkenyl group, or a halogenated alkyl group. Suitable alkyl groups for R²⁰ include methyl, ethyl, propyl, and butyl. Suitable alkenyl groups include vinyl and allyl. Suitable halogenated alkyl groups include trifluoropropyl. Examples of suitable siloxane oligomers for starting material (H3) include 1,1,1,3,3,3—hexamethyldisiloxane.

Suitable capping agents are known in the art and are commercially available, e.g., from Dow Silicones Corporation of Midland, Mich., USA. The capping agent is optional, and the exact amount depends on various factors including the desired structure and silanol content of the branched oxydisilane/siloxane oligomer to be formed. However, the capping may be added in an amount up to 10 mole %, based on total molar amount of halogen atoms in starting material B).

### Method of Use

The branched oxydisilane/siloxane oligomers prepared as described above may be used as heat transfer fluids. For example, particularly when prepared using the method in which A:B ratio ≥1.5:1, the branched oxydisilane/siloxane oligomers may be used in a method of operating a system at an operating temperature of 300° C. to 500° C., such as those disclosed in U.S. Patent Publication 2018/0010027, instead of the branched polydiorganosiloxane described therein.

Alternatively, the branched oxydisilane/siloxane oligomers described herein may be used as heat transfer fluids in various heating and cooling applications such as the chemical or pharmaceutical processing, oil and gas processing, waste heat recovery, food and beverage manufacturing and equipment and product temperature control. The branched polysiloxane compounds may be used as heat transfer fluids at 25° C. to 500° C., alternatively >25° C. to 500° C., alternatively 300° C. to 450° C., alternatively 300° C. to 425° C., alternatively 350° C. to 450° C., alternatively 350° C. to 400° C., and alternatively 300° C. to 500° C.

Alternatively, the branched oxydisilane/siloxane oligomers described herein may be employed as high temperature heat transfer media in solar thermal devices. Alternatively, the branched oxydisilane/siloxane oligomers described herein may be used as heat transfer fluids in CSP plants. A method for operating a CSP plant comprises: 1) concentrating solar energy on a receiver, 2) heating a heat transfer fluid in the receiver, where the heat transfer fluid comprises the branched oxydisilane/siloxane oligomer (as described above), and 3) generating electricity using the heat transfer fluid after heating in step 2). The CSP plant may comprise a system selected from the group consisting of a parabolic trough system, a LFR system, a power tower system, and/or a dish engine system.

### EXAMPLES

These examples are intended to illustrate the invention to one skilled in the art and are not to be interpreted as limiting the scope of the invention set forth in the claims. DPR from Dow Silicones Corporation of Midland, MI, USA was obtained. Trimethylchlorosilane (Me₃SiCl) and a mixture of high boiling components was obtained from the DPR. The mixture contained the components in Table 2, below.

TABLE 2
DPR High Boiling Components, Weight Parts (WP)

| Component | WP |
|---|---|
| 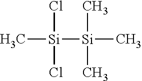 | 2 |
| 1,2,2,2-tetramethyl-1,1-dichlorodisilane | |
| 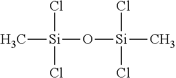 | 5 |
| 1,2-dimethyl-1,1,2,2,-tetrachlorodisiloxane | |
| 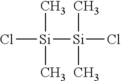 | 7 |
| 1,1,2,2-tetramethyl-1,2-dichlorodisilane | |
| 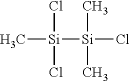 | 23 |
| 1,2,2-trimethyl-1,1,2-trichlorodisilane | |
| 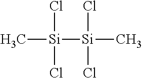 | 57 |
| 1,2-dimethyl-1,1,2,2-tetrachlorodisilane | |

In this Reference Example 1, a branched oxydisilane/siloxane oligomer was prepared by combining the mixture in Table 2 and trimethylchlorosilane by mixing in a vessel. Deionized water was charged into a reactor equipped with a cooling system, an addition system, thermowell, nitrogen inlet and outlet, and agitator. The nitrogen outlet was connected to a NaHCO₃ scrubber. The mixture was fed from the vessel into the reactor via the addition system. Temperature was maintained during the addition via the cooling system. After the addition was complete, the reactor contents were mixed at RT for a period of time.

Toluene (100 mL) was added and mixed for 15 min at RT. The resulting mixture was transferred to a separatory funnel apparatus, phase cut, and the bottom aqueous layer was extracted with toluene. The organic phase was washed with 10% NaHCO₃ (100 mL) three times and deionized water (150 mL) three times. The resulting washed organic phase was dried over MgSO₄. The toluene was then removed with a rotary evaporator, and 14.2 weight parts of crude product was obtained.

The crude product was distilled on a Kugelrohr apparatus at 90° C. for 5 h. An oil product containing some white solids was obtained. A clear oil product was obtained after centrifugation. Three samples were prepared by this method, and the amounts of starting materials and process conditions are shown below in Table 3. Amounts of Mixture, Me₃SiCl, Water, and Product are in weight parts.

TABLE 3
Preparation of Samples 1, 2, and 3

| | Amount | | | | Further | | | Amount |
|---|---|---|---|---|---|---|---|---|
| | of | | | | reaction | Amount | | of |
| | Mixture | Amount of | Amount | Temp. | time at | of | Distillation | clear |
| | in | trimethyl- | of | during | RT | Toluene | Pressure | oil |
| Spl | Table 1 | chlorosilane | water | addition | (h) | (mL) | (mBar) | product |
| 1 | 20 | 32.5 | 315 | 21° C. to | 3.5 | 100 | 0.01 to | 13.1 |
| | | | | 22° C. | | | 0.03 | |
| 2 | 20 | 39 | 354 | 19° C. to | 5.6 | 120 | 0.008 | 9.3 |
| | | | | 22° C. | | | | |
| 3 | 15 | 36.5 | 309 | 19° C. to | 5 | 125 | 0.008 to | 5.4 |
| | | | | 21° C. | | | 0.011 | |

Samples 1, 2, and 3, prepared as described above, were characterized, and the results are summarized in the following Table 4. In Table 4, viscosity is reported in mPa·s and was measured using a Brookfield DV-III Ultra rheometer with cone spindle CPA-40Z at 25° C., Mn was measured by GPC, PD was evaluated by GPC and refers to Mw/Mn.

TABLE 4
Results

| | | | | TGA | Si—OH | Cl | Na | Triflate |
|---|---|---|---|---|---|---|---|---|
| Sample | Viscosity | Mn | PD | (° C.) | (ppm) | (ppm) | (ppm) | (ppm) |
| 1 | 266 | 834 | 1.6 | 121 | 7365 | 36 | 2 | <0.5 |
| 2 | 193 | 784 | 1.34 | 126 | 9733 | 4 | <1 | <0.5 |
| 3 | 209 | 804 | 1.29 | 137 | 9333 | 5 | <1 | <0.5 |

A 24-hour isothermal ARC (Accelerating Rate Calorimetry) test at 400° C. was done to screen for thermal stability of the branched oxydisilane/siloxane oligomers prepared in the Examples described above. Exothermic activity or excessive pressure generation at these conditions was an indication of insufficient thermal stability for some applications. SYLTHERM™ 800 Heat Transfer Fluid was used as a control in the ARC test. SYLTHERM™ 800 Heat Transfer Fluid was a commercially available product: polydimethylsiloxane (PDMS) containing a stabilizer. Two linear PDMS materials were also used for comparison. The first was XIAMETER™ PMX-200 2 cSt Fluid and the second was XIAMETER™ PMX-200 10 cSt Fluid, both of which are commercially available from Dow Silicones Corporation of Midland, Mich., USA. In addition, two branched polymethylsiloxane compounds of formulae [(CH₃)₃SiO_{1/2}]₄(SiO_{4/2}) (abbreviated M₄Q) and [(CH₃)₃SiO_{1/2}]₃(CH₃SiO_{3/2}) (abbreviated M₃T) were also tested. Polyorganosiloxanes of formula M4Q can be prepared as described in U.S. Pat. No. 10,351,747. The temperature/time profile showed that the SYLTHERM™ 800 Heat Transfer Fluid sample was stable at 400° C. for 1 day, and no exothermic reaction was detected. The temperature/time profile also showed that the M₄Q material was thermally unstable as shown by the exotherm detected.

TABLE 5
ARC Test Results

| | Time | Temperature | Pressure | |
|---|---|---|---|---|
| Sample | (min) | (° C.) | (psia) | Comments |
| SYLTHERM ™ | 280 | 400 | 88 | None |
| 800 Heat | 1717 | 400 | 165 | End of search period |
| Transfer | | | | of 1 day |
| Fluid | 1907 | 450 | 428 | End of test |
| | | | | Cooldown P: 21 psia |
| M₄Q | 250 | 400 | 423 | SHR of 0.3° C./min |
| | | | | during wait time |
| | 260 | 405 | 435 | Exotherm detected |
| | 371 | 450 | 657 | End of test |
| | | | | Cooldown P: 19 psia |
| M₃T | 555 | 400 | 796 | None |
| | 1992 | 402 | 872 | End of test period of |
| | | | | 1 day |
| | 2253 | 450 | 1236 | End of test |
| | | | | Cooldown P: 20.5 psia |
| 2 mPa · s | 275 | 400 | 545 | None |
| PDMS | 1715 | 400 | 535 | End of test period of |
| | | | | 1 day |
| | 1910 | 450 | 848 | End of test |
| | | | | Cooldown P: 15.8 psia |
| 10 mPa · s | 290 | 400 | 91 | None |
| PDMS | 1730 | 400 | 216 | End of search period |
| | | | | of 1 day |
| | 1928 | 450 | 711 | End of test |
| | | | | Cooldown P: 18 psia |
| 1 | 403 | 400 | 213 | SHR of 0.13° C./min |
| | | | | during waiting time |
| | 433 | 404 | 299 | Exotherm detected |
| | 591 | 408 | 477 | End of exotherm |
| | 872 | 441 | 797 | Exotherm detected |
| | 1076 | 450 | 856 | End of test |
| | | | | Cooldown P: 133 psia |
| 2 | 199 | 400 | 145 | SHR of 0.15° C./min |
| | | | | during waiting time |
| | 223 | 404 | 216 | Minor exotherm |
| | | | | detected |
| | 492 | 450 | 488 | End of test |
| | | | | Cooldown P: 61 psia |
| 3 | 294 | 400 | 123 | None |
| | 1733 | 407 | 238 | End of search period |
| | | | | of 1 day |
| | 1954 | 450 | 271 | End of test |
| | | | | Cooldown P: 42 psia |

SYLTHERM™ 800 Heat Transfer Fluid was a polydimethylsiloxane containing a stabilizer and was tested as a comparative control. Samples 1, 2, and 3 were tested without including a stabilizer. The ARC test results of the branched oxydisilane/siloxane oligomers showed that Samples 1 and 2, which had ratios of “moles of Cl in Me₃SiCl” to “moles of Cl in the mixture from Table 1” of 1.0 and 1.2; had exothermic reactions at >400° C. But Sample 3 in Table 2, above, had a ratio of “moles of Cl in Me₃SiCl” to “moles of Cl in the mixture from Table 1” (A:B ratio) of 1.5:1, was stable, and passed the ARC test. This was particularly surprising because Sample 3 did not contain a stabilizer, as compared to the control, SYLTHERM™ 800 Heat Transfer Fluid, which did contain a stabilizer. Furthermore, Sample 3 showed lower pressure at 450° C. than SYLTHERM™ 800 Heat Transfer Fluid, which indicated that Sample 3 may be useful as a heat transfer fluid at temperatures higher than SYLTHERM™ 800. Sample 3 showed lower pressure at 450° C. than any of the 10 mPa·s linear PDMS, 2 mPa·s linear PDMS, M₃T, and M₄Q.

The 10 mPa·s linear PDMS was analyzed by GCMS before and after aging at 400° C. for 24 hours. After aging, the molecular weight distribution of the sample was completely changed and moved towards the low molecular weight range as compared to the un-aged sample, and D4 was detected as a major component after aging. Cyclic polydimethylsiloxanes such as D4, D5, and D6 may be undesirable.

The 2 mPa·s linear PDMS was analyzed by GCMS before and after aging at 400° C. for 24 hours. After aging, the molecular weight distribution of the sample was completely changed and significant amount of low molecular weight linear and cyclic compounds as well as high molecular weight species were detected.

The M₃T was analyzed by GCMS before and after aging at 400° C. for 24 hours. After aging, the GCMS showed that majority of M₃T degraded to hexamethyldisiloxane and two high molecular weight species.

Without wishing to be bound by theory, it is thought that Samples 1, 2, and 3 described above will not form cyclic siloxanes such as D3, D4, D5 and D6, upon aging at 400° C. or higher because the branched oligomers described herein do not contain di-functional siloxane (D) units, which would be needed to form the cyclic siloxanes.

In this Example 2, samples were aged at 400° C. for 3 days. Viscosity and weight of each sample were measured before and after aging. In an argon inert glove box, the samples (2.5 — 3.5 g each) were charged into a titanium sphere sample container with ¼″ neck and then capped with Swage lock fitting. The oven test was carried out at 400° C. for three days. The aged materials were discharged from the sphere container. The results are shown below in Table 3.

TABLE 3
Weight Loss and Viscosity Change
After Aging at 400° C. for 3 Days

| Sample | Wt. before | Wt. after | Viscosity | Viscosity |
|---|---|---|---|---|
| Tested | Aging | Aging | before Aging | after Aging |
| 10 cSt PDMS | 2.52 | 2.41 | 11.6 | 8.4 |
| PMX-200 | | | | |
| SYLTHERM ™ | 2.78 | 2.69 | 12.7 | 10.9 |
| 800 Heat | | | | |
| Transfer Fluid | | | | |

In this Example 2, the mixture in Table 2 (15 weight parts) and trimethylchlorosilane (36.5 weight parts) were mixed under an inert atmosphere in a vessel. Deionized water (9.16 weight parts), 1,1,1,3,3,3—hexamethyldisiloxane (M-M) (3.6 weight parts) and trifluoromethanesulfonic acid (CF₃SO₃H) (3.4 μL) were put into a reactor equipped with an agitator, an addition apparatus, cooling apparatus, thermowell, nitrogen inlet and outlet. The nitrogen outlet was connected to a NaHCO₃ scrubber. The mixture was stirred at RT for 5 hours, and then deionized water (300 weight parts) was added. The contents of the vessel were added to the reactor via the addition apparatus over 20 min, and temperature was maintained at 19° C.-23° C. The reactor contents were then stirred at RT overnight.

Toluene (200 mL) was added and stirred for 15 minutes at RT. The resulting mixture was poured into a separatory funnel apparatus and phase cut. The organic phase was then washed with 10% NaHCO₃ solution (150 mL) twice and deionized water (150 mL) three times, and dried over MgSO₄. The toluene was removed with a rotary evaporator, and crude product (9.98 g, Sample 4A) was obtained. A portion of Sample 4A was subject to the residual Si—OH analysis.

The crude product, Sample 4A, (5 weight parts) was stirred with hexamethyldisilazane (HMDZ) (0.724 weight parts) and trimethylchlorosilane (0.049 weight parts) in a vessel at room temperature overnight. A sample was taken (1.57 weight parts), filtered by syringe filter (0.45 μl) and subject to Si—OH analysis (Sample 4B). The remaining mixture was heated at 55° C. for 4 hours, cooled to RT, filtered by syringe filter (0.45 μl) and subject to the residual Si—OH analysis (Sample 4C). The IR experiments showed the further capping process using HMDZ sufficiently reduced Si—OH level—Sample 4A contained 8909 ppm Si—OH, while samples 4B & 4C contained 60 ppm and 34 ppm Si—OH respectively.

The same HMDZ capping process was applied to the remaining crude product (Sample 4A). The post HMDZ capping samples were combined, filtered and further distilled on a Kugelrohr apparatus at 60° C. (0.008 to 0.009 mBar) for 4 hours. An oil product (4.33 g, Sample 4E) was obtained with residual Si—OH of 20 ppm and viscosity of 49.8 mPa·s.

### PROBLEM TO BE SOLVED

The direct process produces DPR that must be disposed of. There is a need in the silicones industry to reuse components of DPR to reduce waste produced by the direct process. And, there is a need in the CSP industry for HTFs with one or more of the following properties: thermal stability at 400° C., a freeze point at or below RT, relatively low vapor pressure, and good heat transfer properties.

### INDUSTRIAL APPLICABILITY

Components of DPR may be used as starting materials to prepare branched oxydisilane/siloxane oligomers, which may be useful as HTFs for various industries, including but not limited to the CSP industry. The examples above show that branched oxydisilane/siloxane oligomers can be prepared using components of DPR as starting materials, and that the oligomers may be useful as HTFs. Certain branched oxydisilane/siloxane oligomers have properties superior to properties of SYLTHERM™ 800 Heat Transfer Fluid (even without the stabilizer used in SYLTHERM™ 800 Heat Transfer Fluid).

### DEFINITIONS AND USAGE OF TERMS

All amounts, ratios, and percentages herein are by weight, unless otherwise indicated. The SUMMARY and ABSTRACT are hereby incorporated by reference. The terms “comprising” or “comprise” are used herein in their broadest sense to mean and encompass the notions of “including,” “include,” “consist(ing) essentially of,” and “consist(ing) of”. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The abbreviations used herein have the definitions in Table 6.

TABLE 6
Abbreviations

| Abbreviation | Definition |
|---|---|
| ° C. | degrees Celsius |
| CSP | concentrated solar power |
| D3 | hexamethylcyclotrisiloxane |
| D4 | octamethylcyclotetrasiloxane |
| D5 | decamethylcyclopentasiloxane |
| D6 | dodecamethylcyclohexasiloxane |
| DPR | direct process residue, produced by the direct |
| | process for manufacturing organohalosilanes, |
| | including dimethyldichlorosilane |
| FBR | fluidized bed reactor |
| GC/MS and | gas chromatography mass spectrometry |
| GCMS | |
| GPC | gel permeation chromatography |
| h | hours |
| HTF | heat transfer fluid |
| IR | Infra-Red |
| m | meter |
| Me | methyl |
| min | minutes |
| mL | milliliters |
| mm | millimeter |
| Mn | number average molecular weight |
| mPa · s | milliPascal seconds |
| M₄Q | tetra(trimethylsiloxy)silane |
| M₃T | tris(trimethylsiloxy)methylsilane |
| Mw | weight average molecular weight |
| PD | polydispersity index, Mw/Mn |
| PDMS | polydimethylsiloxane |
| ppm | parts per million |
| RT | room temperature of 25° C. ± 5° C. |
| TGA | thermogravimetric analysis |
| μl and μL | microliters |
| V | volt |

Test methods used herein are described below.

GPC-GPC experimental conditions are shown below in Table 7.

TABLE 7

| | |
|---|---|
| Sample Prep: | 10 mg/mL in eluent; solvated one hour with occasional |
| | shaking; filtered through 0.45 μm PTFE syringe filters |
| | prior to injection |
| Pump: | Waters 515 at a nominal flow rate of 1.0 mL/min |
| Eluent: | HPLC grade toluene |
| Injector: | Waters 717, 100 μL injection |
| Columns: | Two (300 mm × 7.5 mm) Polymer Laboratories PLgel 5 μm |
| | Mixed-C columns, preceded by a PLgel 5 μm guard column |
| | (50 mm × 7.5 mm), 45° C. |
| Detection: | Waters 2410 differential refractive index detector, 45° C. |
| Data system: | Atlas 8.3, Cirrus 2.0 |
| Calibration: | Relative to 14 narrow polystyrene standards covering the |
| | range of 580 g/mole to 2,300,000 g/mole, fit to a 3rd order |
| | polynomial curve |

TGA-The samples were analyzed by TGA using a TA Instrument Discovery Series TGA analyzer. 20 mg of sample was heated in a Pt pan. The furnace was purged with nitrogen at 60 mL/min and balance was purged with nitrogen at 40 mL/min. The system was equilibrated at 35.00° C. and then ramped to 950.00° C. at 10.00° C/min.

IR-The sample was examined by IR spectroscopy using a single bounce Attenuated Total Reflectance attachment equipped with a diamond crystal. Depth of penetration during the surface analysis was estimated to be 2 microns near 1000 cm⁻¹. The IR spectrum was collected with a Thermo Scientific Nicolet 6700 FTIR spectrometer using 64 scans at 4 cm⁻¹ resolution. The sample -OH level was obtained using the IR deuteration procedure described in “Measurement of Trace Silanol in Siloxanes by IR Spectroscopy” by Elmer D. Lipp, Applied Spectroscopy vol. 45, no. 3, 1991, pp. 477-483.

GC-FID and GC/MS PREPARATION AND EXPERIMENTAL: The sample was analyzed diluted in acetone with a known quantity of internal standard (octane) added using liquid injection gas chromatography mass spectrometry (GC/MS) in El mode with simultaneous GC-flame ionization detection (FID) using the parameters described. Quantitative results are based on weight percent adjusted to the internal standard. Peak identifications for GC-FID were made by comparison to the simultaneous GC/MS data on the same samples. Theoretical response factors were used to determine individual component response relative to the internal standard. Quantitative amounts provided should be considered estimates. This approach does adjust for non-volatiles or non-elutable components from the GC column. Not all components were identified and reported. Annotated GC/MS total ion chromatograms were included for the sample requested for analysis. GC-FID results were provided. The sample was collected on an instrument with dual detection GC/MS and GC-FID. MS14 INSTRUMENT CONDITIONS were as follows: Liquid Injection Analysis Instrument Conditions (MS14): Helium carrier gas
Agilent 7890 column program: 40° C. (1 min)—310° C. (8 min) @ 10° C/min
Column: HP5-MS UI capillary column, 29m×0.25mm×0.25 μm
   constant flow =1.2 mL/min
   Velocity=28 cm/sec
Inlet: split, 270° C.
   50:1 split ratio
   1 uL injection
   Acetone syringe rinse solvent
Detector: Agilent 5977A MSD
   280° C.
   MS scan range 15-1050 m/z
   Threshold 150
   1.5 scans/second
   EI (electron ionization)
Detector: Agilent 7890 FID
   300° C.
   400 mL/min Air
   25 mL/min He makeup
   30 mL/min hydrogen
   20 Hz
   Range =0

GC/MS may not detect highly polar compounds, non-volatile compounds, or high molecular weight (>500 g/mol) compounds. GC/MS is unable to differentiate between isomers with the same empirical formula and mass without representative standards. In general, branched materials will elute before a linear material of the same empirical formula. The mass calibration was verified to be accurate on the day of analysis.

GC/MS data are qualitative only. Although this is a qualitative technique, typically analytes present between 5-100 ppm can be observed using this technique. This estimation is dependent on the analyte's structure and properties and detector response for that day. Estimates of the number of components present cannot be determined using GC/MS alone. Relative amounts of components can usually be determined using a GC technique. GC-FID accuracy and precision parameters have not been determined for this sample type or by the approach used for analysis. Repeatability is estimated to be ±10% (relative) but will likely be dependent on the concentration of individual components.

### Embodiments of the Invention

In a first embodiment, a method for preparing a branched oxydisilane/siloxane oligomer comprises:
1) combining starting materials comprising:
   A) a triorganohalosilane of formula R₃SiX, where each R is an independently selected monovalent hydrocarbon group of 1 to 6 carbon atoms, and each X is an independently selected halogen atom, and
   B) a halodisilane of formula

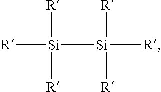

where each R′ is
independently selected from the group consisting of an alkyl group of 1 to 6 carbon
atoms and X, with the proviso that an average of >2 R′ per molecule are halogen atoms; where starting material A) and starting material B) are added in amount such that at least 1.5 moles of halogen atoms on starting material A) :1 mole of halogen atoms on starting material B) are present (i.e., A:B ratio is ≥1.5:1); and
2) adding the mixture to a starting material comprising C) water, thereby forming a reaction product comprising the branched oxydisilane/siloxane oligomer.

In a second embodiment, in the method of the first embodiment, A:B ratio is 1.5:1 to 2:1.

In a third embodiment, in the method of the first embodiment or the second embodiment, each X is Cl.

In a fourth embodiment, in the method of any one of the first to third embodiments, each alkyl group for R′ is methyl.

In a fifth embodiment, in the method of any one of the first to fourth embodiments, B) the halodisilane has an average of ≥2 to ≤4 R′ per molecule are Cl.

In a sixth embodiment, the method of any one of the first to fifth embodiments further comprises: adding D) a strong acid to C) the water before step 2).

In a seventh embodiment, the method of any one of the first to sixth embodiments further comprises:
3) adding E) an organic solvent to the reaction product, thereby preparing an incompatible mixture comprising an organic phase and an aqueous phase,
4) phase separating the incompatible mixture, thereby recovering the organic phase and the aqueous phase in separate vessels, and
5) washing the organic phase with F) a neutralizing agent; and
optionally 6) repeating steps 4) and 5) two or more times.

In an eighth embodiment, the method of any one of the first to seventh embodiments further comprises:
7) drying the reaction product.

In a ninth embodiment, the method of any one of the first to eighth embodiments further comprises:
8) combining the branched oxydisilane/siloxane oligomer with H) a capping agent.

In a tenth embodiment, the method of any one of the first to ninth embodiments further comprises:
9) recovering the branched oxydisilane/siloxane oligomer.

In an eleventh embodiment, a branched oxydisilane/siloxane oligomer is prepared by practicing the method steps of any one of the first to tenth embodiments.

In a twelfth embodiment, the oligomer comprises unit formula: (R″₄Si₂O_{2/2})ₘ(R″₃Si₂O_{3/2})ₙ(R″₂Si₂O_{4/2})ₒ(R₃SiO_{1/2})_{z}(HO_{1/2})_{y}, where each R″ is an independently selected alkyl group of 1 to 6 carbon atoms; each R is an independently selected monovalent hydrocarbon group of 1 to 6 carbon atoms; subscript m≥0, subscript n≥0, subscript o≥0, with the provisos that a quantity (n+o)≥1, and a quantity (m+n+o)≤3; and subscript y≥0, subscript z≥3; and a quantity (y+z)=[n+(2×o)+2].

In a thirteenth embodiment, the oligomer of the twelfth embodiment has each R is selected from the group consisting of alkyl, alkenyl, and aryl.

In a fourteenth embodiment, the oligomer of the thirteenth embodiment has R is selected from the group consisting of methyl, vinyl, and, phenyl.

In a fifteenth embodiment, the oligomer of any one of the twelfth to fourteenth embodiment has each R″ is methyl.

In a sixteenth embodiment, the oligomer of any one of the eleventh to fifteenth embodiments is used as a heat transfer fluid.

In a seventeenth embodiment, a method for operating a concentrated solar power plant comprises: 1) concentrating solar energy on a receiver, 2) heating a heat transfer fluid in the receiver, where the heat transfer fluid comprises the branched oxydisilane/siloxane oligomer of any one of the eleventh to fifteenth embodiments, and 3) generating electricity using the heat transfer fluid after heating in step 2).

In an eighteenth embodiment, in the method of the seventeenth embodiment, the concentrated solar power plant comprises a system selected from the group consisting of a parabolic trough system, a linear Fresnel reflector system, a power tower system, a dish engine system, and two or more thereof.

The invention has been described in an illustrative manner, and it is to be understood that the terminology which has been used is intended to be in the nature of words of description rather than of limitation. With respect to any Markush groups relied upon herein for describing particular features or aspects, different, special, and/or unexpected results may be obtained from each member of the respective Markush group independent from all other Markush members. Each member of a Markush group may be relied upon individually and or in combination and provides adequate support for specific embodiments within the scope of the appended claims.

Furthermore, any ranges and subranges relied upon in describing the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range of “1 to 18” may be further delineated into a lower third, i.e., 1 to 6, a middle third, i.e., 7 to 12, and an upper third, i.e., from 13 to 18, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit.

1. A method comprising using a branched oxydisilane/siloxane oligomer comprising unit formula: ((R″₄Si₂O_{2/2})ₘ(R″₃Si₂O_{3/2})ₙ(R″₂Si₂O_{4/2})ₒ(R₃SiO_{1/2})_{z}(HO_{1/2})_{y}, where each R″ is an independently selected alkyl group of 1 to 6 carbon atoms; each R is an independently selected monovalent hydrocarbon group of 1 to 6 carbon atoms; subscript m≥0, subscript n≥0, subscript o≥0, with the provisos that a quantity (n+o)≥1, and a quantity (m+n+o)≤3; and subscript y≥0, subscript z≥3; and a quantity (y+z)=[n+(2×o)+2] as a heat transfer fluid.

2. The method of claim 1, where each R is selected from the group consisting of alkyl, alkenyl, and aryl.

3. The method of claim 1, where each R″ is methyl.

4. The method of claim 1, where the branched oxydisilane/siloxane oligomer has an empirical formulae selected from the group consisting of: C₂₂H₆₆O₇Si₁₀, C₁₉H₅₈O₇Si₉, C₂₀H₆₀O₆Si₉, C₁₇H₅₂O₆Si₈, and a combination of two or more thereof.

5. A method for preparing a branched oxydisilane/siloxane oligomer, where the method comprises:
1) combining starting materials comprising:
A) a triorganohalosilane of formula R₃SiX, where each R is an independently selected monovalent hydrocarbon group of 1 to 6 carbon atoms, and each X is an independently selected halogen atom, and
B) a halodisilane of formula 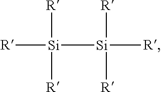
where each
R′ is independently selected from the group consisting of an alkyl group
of 1 to 6 carbon atoms and X, with the proviso that an average of >2 R′
per molecule are halogen atoms; where starting material A) and starting material B) are added in amount such that at least 1.5 moles of halogen atoms on starting material A) :1 mole of halogen atoms on starting material B) are present (i.e., A:B ratio is ≥1:1); and
2) adding the mixture to a starting material comprising C) water, thereby forming a reaction product comprising the branched oxydisilane/siloxane oligomer.

6. The method of claim 5, where each X is Cl.

7. The method of claim 5, where each alkyl group for R′ is methyl.

8. The method of claim 5, where B) the halodisilane has an average of ≥2 to ≤4 R′ per molecule are Cl.

9. The method of claim 5 further comprising:
adding D) a strong acid to C) the water before step 2).

10. The method of claim 5 further comprising:
3) adding E) an organic solvent to the reaction product, thereby preparing an incompatible mixture comprising an organic phase and an aqueous phase,
4) phase separating the incompatible mixture, thereby recovering the organic phase and the aqueous phase in separate vessels, and
5) washing the organic phase with F) a neutralizing agent; and
optionally 6) repeating steps 4) and 5) two or more times.

11. The method of claim 10, further comprising:
7) drying the reaction product.

12. The method of claim 5, further comprising:
8) combining the branched oxydisilane/siloxane oligomer with H) a capping agent.

13. The method of claim 5, further comprising:
9) recovering the branched oxydisilane/siloxane oligomer.

14. The method of claim 5, further comprising using the branched oxydisilane/siloxane oligomer as a heat transfer fluid.

15. (canceled)

16. The method of claim 14, wherein the method further comprises:
1) concentrating solar energy on a receiver,
2) heating the heat transfer fluid in the receiver, and
3) generating electricity using the heat transfer fluid after heating in step 2).

17. The method of claim 1, wherein the method comprises:
1) concentrating solar energy on a receiver,
2) heating the heat transfer fluid in the receiver, and
3) generating electricity using the heat transfer fluid after heating in step 2).
